(19) United States
(12) Patent Application Publication
(10) Pub. No.: US 2026/0358785 A1
(43) Pub. Date: Nov. 12, 2026

(54) TRACEABILITY MANAGEMENT SYSTEM AND TRACEABILITY MANAGEMENT METHOD

(71) Applicant: GS YUASA International Ltd., Kyoto-shi, Kyoto (JP)

(72) Inventors: Teruo YAMANE, Kyoto-shi, Kyoto (JP); Tatsushi MORI, Kyoto-shi, Kyoto (JP); Hirofumi IMAIZUMI, Kyoto-shi, Kyoto (JP); Keita NAKAI, Kyoto-shi, Kyoto (JP)

(21) Appl. No.: 19/137,987

(22) PCT Filed: Nov. 13, 2023
(86) PCT No.: PCT/JP2023/040670

§ 371 Date: Jun. 11, 2025

(30) Foreign Application Priority Data
Dec. 12, 2022 (JP) 2022-198019

(51) Int. Cl. G05B 19/406

(52) U.S. Cl. CPC G05B 19/406; G05B 2219/15097

(57) ABSTRACT

A traceability management system includes a data relay device that accepts traceability data of a plurality of components input from each of a plurality of inputters permitted to access, and an information processing device that acquires the traceability data from the data relay device, and stores the traceability data in association with a local system in such a manner that a place in the local system of a component having specific traceability data can be searched for.

### CROSS REFERENCE TO RELATED APPLICATIONS

This application is a National Stage Application, filed under 35 U.S.C. § 371, of International Application No. PCT/JP2023/040670, filed Nov. 13, 2023, which international application claims priority to and the benefit of Japanese Application No. 2022-198019, filed Dec. 12, 2022; the contents of both of which are hereby incorporated by reference in their entirety.

### BACKGROUND

### Technical Field

One aspect of the present disclosure relates to a traceability management system and a traceability management method.

### Description of Related Art

Japanese Patent Application Publication JP-A-2022-162314 discloses a traceability management device that is applied to a manufacturing line of an automobile industry and that clarifies an assembly section to an automobile for each manufacturing lot of parts. With this management device, it is possible to quickly investigate a cause when a defect occurs in a manufactured product (automobile).

### BRIEF SUMMARY

Japanese Patent Application Publication JP-A-2022-162314 discloses a technology for ensuring traceability of parts assembled to a manufactured product in the same factory of one company.

The present inventors have studied about ensurance of traceability in a case of assembling a plurality of types of components manufactured in different factories or components manufactured in different places by a plurality of companies in an assembly factory or at an installation site of a manufactured product.

In particular, the present inventors have studied traceability (traceability of manufacturing information for each main component) in a case of constructing or operating an energy storage system (hereinafter, also referred to as ESS) including an energy storage block and a housing that houses a plurality of energy storage blocks.

One aspect of the present invention provides a highly flexible traceability management system and a highly flexible traceability management method.

A traceability management system according to one aspect of the present invention includes a data relay device that accepts traceability data (manufacturing number, lot number and the like) of a plurality of components input from each of a plurality of inputters permitted to access, and an information processing device that acquires the traceability data from the data relay device, and stores the traceability data in association with a local system in such a manner that a place in the local system of a component having specific traceability data can be searched for.

According to the above-described aspect, it is possible to provide a highly flexible traceability management system. The traceability management according to the above-described aspect can also be applied to construction or operation of an energy storage system.

### BRIEF DESCRIPTION OF THE FIGURES

FIG. 1 is a diagram illustrating an outline of a traceability management system.

FIG. 2 is a diagram illustrating an outline of an ESS.

FIG. 3 is a diagram illustrating an electrical configuration in a container.

FIG. 4 is a perspective view of a protection unit.

FIG. 5 is a diagram for explaining association between high-order and low-order for traceability management in the ESS and a storage battery board.

FIG. 6 is a diagram illustrating an example of a monitoring screen by a remote monitoring system.

FIG. 7 is a diagram for explaining another example of association between high-order and low-order for traceability management.

### DETAILED DESCRIPTION OF VARIOUS EMBODIMENTS

First, an outline of a traceability management system according to an embodiment will be described.

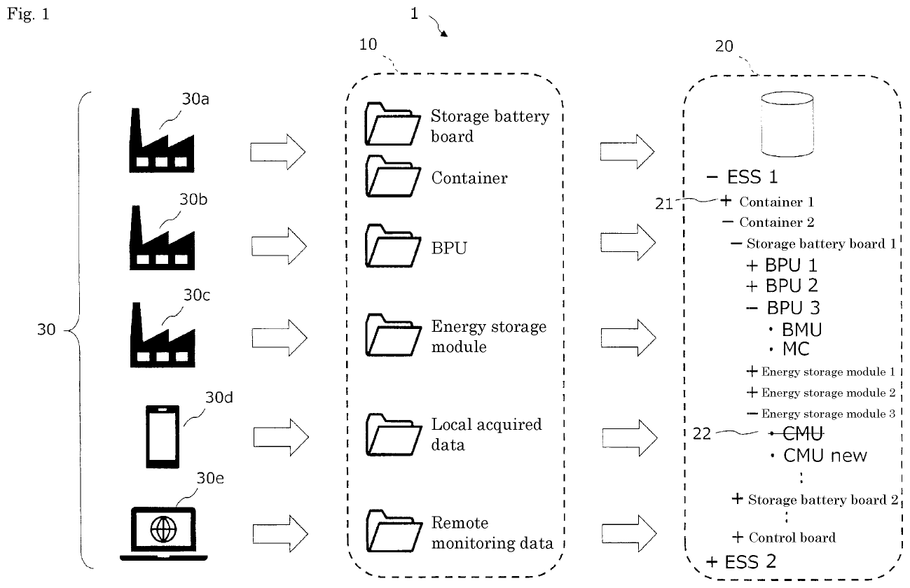

As illustrated in FIG. 1, a traceability management system 1 includes a data relay device 10 that accepts traceability data of a plurality of components input from each of a plurality of inputters 30 permitted to access.

The plurality of inputters 30 may be terminal devices such as personal computers provided in a plurality of different factories 30a, 30b, and 30c or provided in a plurality of companies 30a, 30b, and 30c in different places. The terminal device is communicably connectable to the data relay device 10 via a network. In the present embodiment, it is not necessary to install a specific application (software) in the terminal device in order to input data to the traceability management system 1. In the terminal device according to the present embodiment, a general web browser is installed.

The network includes a public communication network, which is the so-called Internet, and a carrier network, which implements wireless communication according to a predetermined mobile communication standard. The network may include a local area network such as an in-house LAN, or may include a general optical line or a dedicated line.

The plurality of inputters 30 may further include a terminal device 30d capable of reading code information of a component in a factory or a local system and inputting the traceability data to the data relay device 10. The terminal device 30d may be a mobile terminal device such as a smartphone, a tablet, or a handy terminal.

The plurality of inputters 30 may include an external cooperation system such as a remote monitoring system 30e for remotely monitoring the local system and a customer data management system.

The data relay device 10 includes a storage unit having a folder configuration in which the plurality of inputters 30 permitted to access can input and share the traceability data of the components or a file in which the traceability data of the components is described. The storage unit may include an in-house shared folder. The data relay device 10 may be structured by a plurality of server devices, or may be a so-called cloud server.

The data relay device 10 according to the present embodiment is constructed by customizing a file sharing service, of which access setting can be performed, provided on the cloud server. Therefore, unlike a case of an on-premises system, it is not necessary to periodically update software in accordance with replacement of hardware such as a server device for traceability management. Some inputters 30 may directly input the traceability data to an information processing device 20. The data relay device 10 in the present embodiment can accept data from a new terminal device only by permitting access, and has excellent extensibility.

As another embodiment not illustrated, the traceability management system 1 may be constructed as an on-premises system.

The traceability management system 1 further includes the information processing device 20 that acquires the traceability data from the data relay device 10 as an event (for example, at predetermined time of day). Alternatively, the information processing device 20 may acquire the traceability data from the data relay device 10 in response to a request (for example, in response to a request from a terminal device (not illustrated) connected to a network). The information processing device 20 may be structured by one or a plurality of server devices. The data relay device 10 described above may be integrated with the information processing device 20.

The information processing device 20 may execute data processing (batch processing) such as a data overlap check, a data omission check, and addition of information (for example, an item code) on the traceability data of the component. Since the information processing device 20 has a data processing function, it is possible to reduce a load on an input by the inputter 30.

Through the data processing, the information processing device 20 stores the traceability data associated with the item code with hierarchy defined for each local system. The local system may be a stationary system.

The traceability management using such traceability management system 1 can be applied to construction or operation of an ESS. When a failure or a defect occurs in a certain ESS and a component causing the same is specified, it is possible to grasp a propagation scope of a component having the same traceability data. It is possible to grasp not only the propagation scope in the same ESS but the propagation scope across a plurality of ESSs.

The information processing device 20 of the traceability management system 1 stores the traceability data such that a place (location or position) in the local system of a component having specific traceability data can be searched for and specified.

In the ESS including a large number of components (containers, boards, energy storage blocks and the like) having the same appearance, it is very useful that the place in the ESS of the component having specific traceability data can be searched for and specified. This function improves maintenance efficiency of the ESS, and enables stable operation and preventive maintenance of the system.

In order to describe such a technical effect, an outline of the ESS and hierarchy (hierarchical structure) for the traceability management in the ESS will be described.

The ESS is increasingly introduced in order to expand use of renewable energy, promote energy management, and promote power interchange and power distribution. The ESS is often operated for a long period of time such as 15 or 20 years. Therefore, there is an increasing need for a remote monitoring service for monitoring a state of the components of the ESS and a maintenance service for performing periodic inspection, part replacement, and troubleshooting during an operation period.

By applying the traceability management, it is possible to stably provide the remote monitoring service and the maintenance service of the ESS with high reliability. In addition to the components at the time of ESS construction (new installation), it is desirable to ensure traceability also for replacement parts during the operation period over 10 years or longer. The ESS is typically constructed as follows.

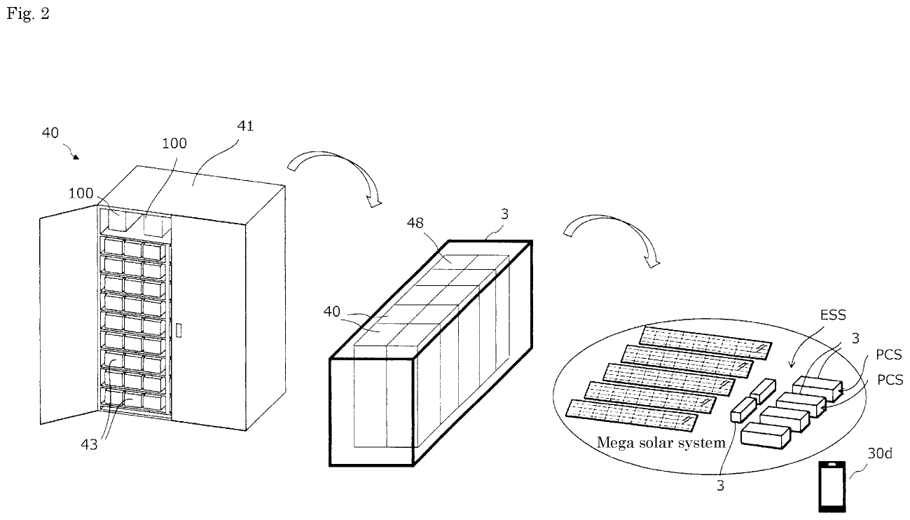

As illustrated in FIG. 2, a storage battery board 40 includes a board 41 made of metal (a type of a housing), and a plurality of energy storage modules 43 (a type of energy storage blocks) is housed in the board 41. The plurality of energy storage modules 43 forms a plurality of groups (banks). The board 41 illustrated in FIG. 2 houses three banks each including two rows in a vertical direction of the energy storage modules 43.

In an example of FIG. 2, each bank includes a total of eighteen energy storage modules 43 electrically connected in series in two rows in the longitudinal direction. The number of energy storage modules 43 forming each bank can be optionally selected. For example, the bank may include one and a half rows in the vertical direction of the energy storage modules 43 or one row in the vertical direction of the energy storage modules 43.

The storage battery board 40 is provided as a product in a different voltage band by changing the number of energy storage modules 43 forming each bank. For example, as illustrated in FIG. 2, by connecting two rows in the vertical direction of the energy storage modules 43 in series to form one bank, a 1200 V storage battery board 40 is provided.

Although not illustrated, products in different voltage bands such as 600 V, 750 V, and 900 V can be provided by reducing the number of energy storage modules 43 forming the bank. The storage battery boards 40 in such different voltage bands with substantially the same appearance are associated with different item codes (information indicating what the component is).

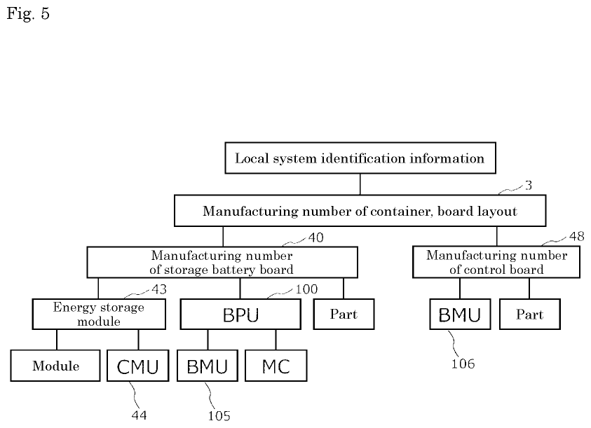

A protection unit 100 (also referred to as a battery protection unit (BPU) in FIG. 5) is arranged above each bank. In the example of FIG. 2 in which three banks are housed in the board 41, three protection units 100 are arranged side by side in a lateral direction in the board 41. Alternatively, the protection unit 100 may be arranged below each bank.

The storage battery board 40 is assembled in a certain factory, and the traceability data (serial number, manufacturing number including branch number and the like) of the storage battery board 40 is stored in the information processing device 20 (refer to FIG. 1).

The traceability data of a container 3 (a type of a housing) illustrated in FIG. 2 is stored in the information processing device 20 in the same factory as the storage battery board 40, another factory, or an installation site of the ESS. Methods for constructing the ESS include a local assembly method and a factory completion method (manufacturer completion method).

In a case of the local assembly method, a plurality of storage battery boards 40 is housed in the container 3 (or an energy storage room of a building) at the installation site of the ESS, and the ESS is constructed together with a power conditioner (PCS) not illustrated. In the present specification, storage battery facility (a storage battery system at the center of FIG. 2) excluding the power conditioner is also included in the meaning of the ESS.

In the present embodiment, nine storage battery boards 40 and one control board 48 are housed in the container 3. Therefore, the traceability data of the nine storage battery boards 40 and the traceability data of the one control board 48 are associated with the traceability data of the container 3. The same applies to a case of the manufacturer completion method in which housing in the container 3 is performed in a factory.

As described later, the container 3 may be omitted as long as the storage battery board 40 has waterproofness and dustproofness that allow outdoor installation.

In the example of FIG. 2, since fifty-four energy storage modules and three protection units 100 are housed in one board 41, the container 3 includes four hundred and eighty-six (=54×9) energy storage modules 43 and twenty-seven (=3×9) protection units 100. The ESS often includes a plurality containers 3 instead of one container 3 (on the right in FIG. 2). In this manner, in the ESS, a large number of components (the containers 3, boards 41, energy storage modules 43, protection units 100 and the like) having the same appearance are densely arranged.

The constructed ESS is associated with local system identification information (for example, customer identification information) via the terminal device 30d. For example, the terminal device 30d reads the code information (for example, bar code information or two-dimensional code information) attached to the container 3 in a state in which specific local system identification information is selected, and the traceability data of the container 3 is associated with the local system identification information. In a case where the ESS includes a plurality of containers 3, the plurality of containers 3 is associated with the local system identification information.

In this manner, the traceability data of the container 3 is associated with the traceability data of the storage battery board 40 and the control board 48 housed in the container 3 along the hierarchy of the ESS (refer to FIG. 5), that is, the local system identification information-the container-the storage battery board, and the local system identification information-the container-the control board. Association of the components along the hierarchy of the ESS is highly versatile. With the same concept, the traceability management of the ESS in a plurality of different voltage bands can be performed.

Next, a configuration of the storage battery board 40 and the hierarchy (hierarchical structure) for the traceability management in the storage battery board 40 will be described.

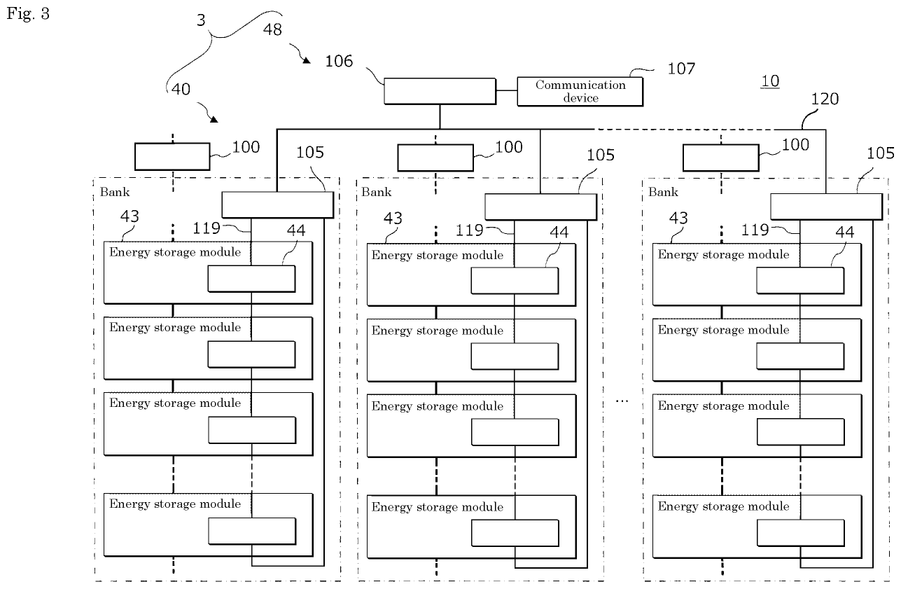

FIG. 3 illustrates an electrical configuration in the container 3. The plurality of energy storage modules 43 (energy storage blocks) is connected in series to form the bank. The protection unit 100 is provided on a power line (main circuit line) of each bank. The protection unit 100 includes a switch to protect the energy storage module 43 of the bank from overcharge and overcurrent.

Management units 105 and 106 (also referred to as battery management units (BMUs) in FIG. 5) are provided in each bank and a group obtained by connecting a plurality of banks in parallel (hereinafter, referred to as a domain), respectively.

The energy storage module 43 includes a module (in the lower left in FIG. 5, also referred to as an assembled battery) formed by connecting a plurality of power storage cells (in the present embodiment, a lithium ion secondary battery) in series and/or in parallel. The power storage cell may be a prismatic cell (prismatic cell), a cylindrical cell, or a laminate-type cell (pouch cell).

The management unit 105 provided in each bank communicates with a monitoring board 44 (also referred to as a cell management unit (CMU) in FIG. 5) included in each energy storage module 43 in the bank via a communication line 119. The management unit 105 acquires state data (measurement data such as a cell voltage and temperature) of the energy storage module 43 and the power storage cell.

As described later, the module and the monitoring board 44 included in the energy storage module 43 can be exchanged separately. In the ESS, the number of modules and the number of monitoring boards 44 are very large (in the example of FIG. 2, four hundred and eighty-six for one container 3), and there is a relatively high possibility that partial replacement is required during the operation.

The management unit 106 provided in the domain can communicate with the management unit 105 of each bank via a communication bus 120, and aggregates the state data of the energy storage module 43 and the power storage cell acquired by the management unit 105.

A communication device 107 is connected to the management unit 106 of the domain.

The communication device 107 transmits the state data acquired from each management unit 105 via the management unit 106 to, for example, a remote monitoring system (remote monitoring server) not illustrated. The communication device 107 may be a network card type communication device (network interface card). The management unit 106 and the communication device 107 are housed in the control board 48 (refer to FIG. 2).

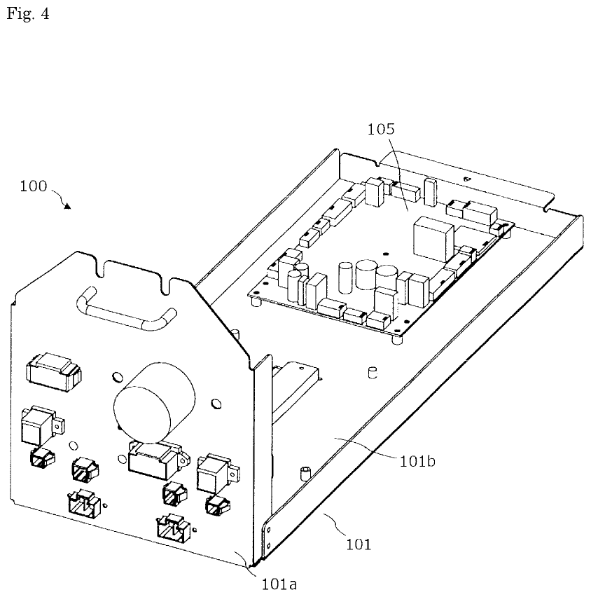

As illustrated in FIG. 4, a support member 101 of the protection unit 100 includes a front surface panel 101a and a lower surface panel 101b. The management unit 105 of the bank, an electromagnetic contactor not illustrated as a switch (also referred to as a magnet contactor (MC) in FIG. 5), and other parts are supported on the lower surface panel 101b.

As illustrated in FIG. 5, in the present embodiment, the traceability data of fifty-four energy storage modules 43, the traceability data of three protection units 100, and the traceability data of other parts are associated with the traceability data of each storage battery board 40 housed in the container 3.

The traceability data of one module and the traceability data of one monitoring board 44 are associated with the traceability data of each energy storage module 43.

The traceability data of one management unit 105, the traceability data of the electromagnetic contactor MC, and the traceability data of other parts (such as fuse) not illustrated are associated with the traceability data of each protection unit 100.

In this manner, the traceability data are associated along the hierarchy of the storage battery board 40, that is, the storage battery board-the energy storage module—the module—the monitoring board, and the storage battery board-the protection unit-the management unit-the electromagnetic contactor.

The traceability data of the management unit 106 of the domain and the traceability data of other parts are associated with the traceability data of the control board 48.

In addition to the hierarchy in the storage battery board 40 described above, bank identification information (hereinafter, referred to as a total bank number) across a plurality of storage battery boards 40 (for example, in an entire ESS) is assigned to the bank in each storage battery board 40. Necessity of the total bank number and an example of an assigning method thereof will be described.

In the example of FIG. 2, three banks are housed in the board 41. For example, by assigning identification information such as A, B, and C to the banks in the factory of the storage battery board 40, it is possible to specify which bank on a left side (A), the center (B), and a right side (C) in the board 41 a certain bank is. That is, the traceability data of the bank is configured by a set of the item code indicating the storage battery board 40 including three banks, the manufacturing number of the storage battery board 40, and the identification information of any one of A to C.

Similarly, in a case where six banks are housed in the board 41, it is possible to specify which bank in the board 41 a certain bank is by assigning reference signs A to F to the banks.

That is, the traceability data of the bank is configured by a set of the item code indicating the storage battery board 40 including six banks, the manufacturing number of the storage battery board 40, and the identification information of any one of A to F.

However, since a plurality of (nine in the example of FIG. 2) storage battery boards 40 is housed in the container 3, it is not possible to specify in which place in the container 3 a certain bank is located only by assigning reference signs A to C to every three banks. This is because it is not known how the nine storage battery boards 40 are laid out in the container 3. Also in a case where a large number of storage battery boards 40 are housed in the energy storage room of the building in place of the container 3, it is not possible to specify in which place in the energy storage room a certain bank is located only by assigning reference signs A to C to every three banks.

Therefore, it is necessary to assign the total bank number across the plurality of storage battery boards 40 to the bank in each storage battery board 40 in addition to the bank identification information (A to C and the like) for each storage battery board 40.

International Patent Application PCT/JP2022/032030 filed by the same applicant as the present patent application (the content related to the bank number assignment is incorporated in the present patent application by reference) discloses, as a related technology, a technology for reproducing the arrangement of banks in a local ESS on a web screen provided by the remote monitoring system. When the ESS is constructed, the identification data is sequentially transmitted from a high-order device, and switches of a plurality of bank management units each including a switch are sequentially operated to store the identification data in each bank management unit. Accordingly, the total bank number is assigned to each bank management unit The traceability management system 1 of the present embodiment illustrated in FIG. 1 has a data cooperation function with the remote monitoring system 30e.

The traceability management system 1 may provide the traceability data of all the storage battery boards 40 (including the traceability data of all the energy storage modules 43) illustrated in FIG. 2 to the remote monitoring system 30e when the ESS is constructed.

The traceability management system 1 acquires data of the total bank number from the remote monitoring system 30e that grasps the total bank number of each bank management unit according to the technology of the above-described International Patent Application. The information processing device 20 acquires data of the total bank number associated with the traceability data of each storage battery board 40 from the remote monitoring system 30e.

In a case where the ESS is constructed by the local assembly method, the information processing device 20 may acquire the total bank number sequentially assigned to each bank management unit by the technology of the above-described International Patent Application.

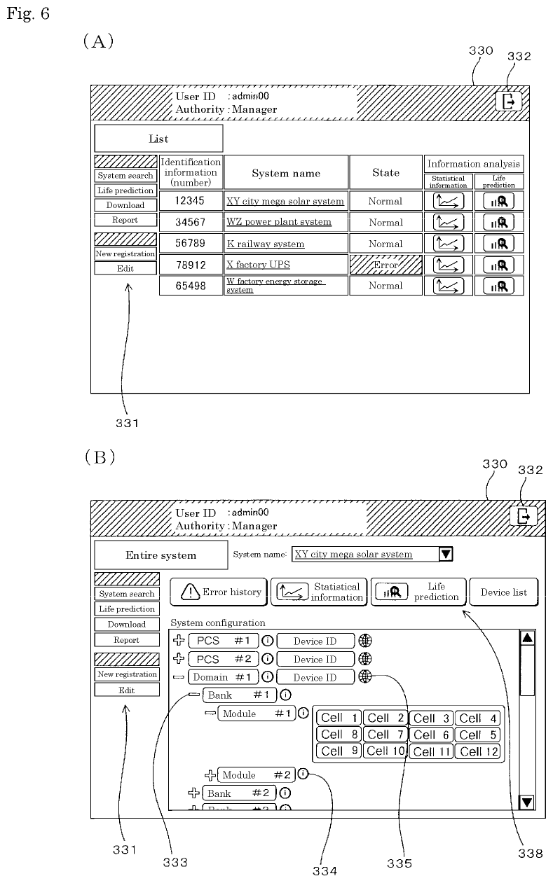

The remote monitoring system 30e has a web server function as disclosed in Japanese Patent No. 6604373 by the same applicant as the present patent application, and transmits screen information of a web screen 330 (a screen displayed on a display unit of a client device connected to a network) illustrated in FIG. 6(A), for example.

The web screen 330 includes a menu 331 such as “system search”, “life prediction”, “download”, and “report. When “system search” is selected in the menu 331, a page including a list of link information for systems to which a user logged in to the remote monitoring server has access authority is displayed. The web screen 330 includes a button 332 for logout or end operation.

When a certain system is selected from the link information list of FIG. 6(A), the screen transitions to the web screen of FIG. 6(B). FIG. 6(B) illustrates two power conditioners (PCSs) and a plurality of banks included in the domain in accordance with the configuration of the ESS in “XY city mega solar system”. An icon 333 indicating “+” or “−” for expanding and folding a hierarchical structure of the bank and module, an icon 334 for displaying detailed information, a link 335 to a network interface card and the like are arranged on the screen. A menu icon 338 for the selected system is included in the screen.

The information processing device 20 illustrated in FIG. 1 stores the traceability data for each local system in a tree structure similar to that in FIG. 6(B), for example. The information processing device 20 may have a web server function and provide a hierarchical structure (tree structure) an outline of which is illustrated in FIG. 1 to a terminal device (client device) connected to a network on the web screen.

Although FIG. 1 illustrates only “energy storage module 1, energy storage module 2, energy storage module 3, . . . ” of one bank out of a plurality of banks included in “storage battery board 1” in “container 2”, the “storage battery board 1” actually includes three banks. The energy storage modules of the banks can be displayed by operating an icon 21 of “+” or “−” on the web screen.

The information processing device 20 stores in a searchable manner in which place (physical place) of which housing in the ESS a component having specific traceability data is provided.

For example, it is assumed that a defect occurs in monitoring board “CMU” included in “energy storage module 3” of “storage battery board 1” included in “container 2” in “ESS1” illustrated in FIG. 1. For example, the manufacturing number of the monitoring board “CMU” of “energy storage module 3” is input to a search box prepared on the web screen by the information processing device 20. Then, it is possible to instantly search for the energy storage module in the container 2 in which the monitoring board “CMU” having the same traceability data is used, whether this is used for an adjacent “container 1”, whether this is used for “ESS2” in another place and the like. The information processing device 20 transmits screen information of the web screen displaying a search result to the client device.

Instead of the web screen provided by the information processing device 20, the traceability data of the ESS component can be confirmed on the web screen provided by the remote monitoring system illustrated in FIG. 6.

Furthermore, the replacement part can be identified on the web screen provided by the information processing device 20.

In a case where a defect occurs in the monitoring board of “energy storage module 3” and a maintenance staff replaces the monitoring board with a new monitoring board on site, as illustrated in FIG. 1, an old monitoring board “CMU” is displayed with a strikeout or is grayed out. Then, a new monitoring board “CMU new” is displayed adjacent to the old monitoring board. Therefore, it is possible to intuitively grasp which component is replaced with which component on the web screen provided by the information processing device 20. “CMU” and “CMU new” herein used are notation examples for description, and in practice, alphabetic and numerical notations may be used.

In order to implement identification of the replacement part, the maintenance staff reads the code information of the monitoring board “CMU” removed on site with the terminal device 30d, and inputs the same to the data relay device 10 in association with the traceability data of the “energy storage module 3”. Similarly, the maintenance staff reads the code information of a new monitoring board “CMU new” with the terminal device 30d, and inputs the same to the data relay device 10 in association with the traceability data of the “energy storage module 3”.

In a case where an entire energy storage module is replaced instead of replacing only the monitoring board “CMU”, the maintenance staff reads the code information of the old and new energy storage modules with the terminal device 30d, and inputs the same to the data relay device 10 in association with the traceability data of “storage battery board 1”.

The information processing device 20 may provide the stored traceability data of the new and old components to the remote monitoring system 30e so that the traceability data can be confirmed on a web screen provided by the remote monitoring system.

The present invention is not limited to the above-described embodiment.

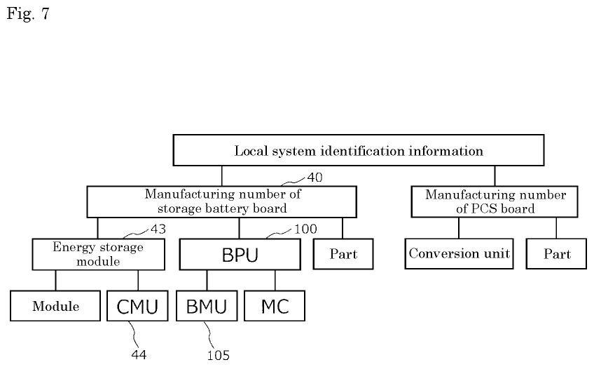

In a case of the ESS in which a plurality of storage battery boards 40 and the power conditioner (PCS) are installed outdoors without providing a container, high-order and low-order association for traceability management as illustrated in FIG. 7 may be adopted. Specifically, the traceability data is associated with the local system identification information-the plurality of storage battery boards 40, and the local system identification information-the PCS board. The local system identification information may include layout information such as the total bank number. The traceability data of a plurality of conversion units provided in the power conditioner and the traceability data of other parts (control unit and the like) are associated with the traceability data of the PCS board.

The traceability management by the traceability management system 1 may be applied to a system other than the ESS. For example, similarly to the ESS, it is possible to apply to a system (power supply system and the like) operated for a long period of 10 years or longer, a remotely monitored system, and a system requiring part replacement.

The data relay device 10 may be a portable storage medium. However, from the viewpoint of efficiency of data transmission/reception, the data relay device 10 that performs data transmission/reception via the network illustrated in FIG. 1 is preferable.

Instead of the energy storage module 43, for example, a long power storage cell extending from a front surface to a back surface of the board 41 (housing) may be housed in the board 41. A plurality of long power storage cells may be connected in series to form a bank.

As the switch, a molded case circuit breaker (MCCB) may be used instead of the electromagnetic contactor (MC) that is opened and closed by a signal from the management unit 105.

A summary of the embodiment and technical effects will be described below.

(1) A traceability management system 1 includes a data relay device 10 that accepts traceability data of a plurality of components input from each of a plurality of inputters 30 permitted to access, and an information processing device 20 that acquires the traceability data from the data relay device 10, and stores the traceability data in association with a local system in such a manner that a place in the local system of a component having specific traceability data can be searched for.

According to the above-described configuration, by using the data relay device 10, the traceability data can be aggregated in a case of assembling a plurality of types of components manufactured in different factories or components manufactured in different places by a plurality of companies in an assembly factory or at an installation site of a manufactured product. It is not necessary to install a specific application in a terminal device in order to input data to the traceability management system 1. The data relay device 10 can be constructed by customizing a file sharing service, of which access setting can be performed, provided on a cloud server, and/or by using an in-house shared folder. According to the above-described configuration, it is possible to provide a highly flexible traceability system 1 with a small initial cost.

(2) In the traceability management system 1 of (1) described above, the local system may be an ESS including a plurality of housings 41 (or 3) that accommodates a plurality of energy storage blocks 43 (or 40), and the information processing device 20 may store in a searchable manner in which place of which housing 41 (or 3) in the ESS the component having specific traceability data is provided (in such a manner that a place in the ESS can be searched for and specified on a screen based on screen information such as web screen information provided by the information processing device 20).

According to the above-described configuration, it is possible to provide the traceability system 1 suitable for construction and operation of the ESS. In the ESS, a large number of components (the containers 3, boards 41, energy storage modules 43, protection units 100 and the like) having the same appearance are densely arranged as trees densely crowded in a forest. Since the place of the component having specific traceability data in the ESS can be searched for and specified, maintenance efficiency is dramatically improved. The ESS is required not to stop the system as much as possible and to recover the system as soon as possible when the system is stopped for various purposes such as stabilization of system power, efficient utilization of power by energy management, and acquisition of opportunities of power distribution. With the traceability management system 1 of the present embodiment, stable operation and preventive maintenance of the system can be performed, and reliability of the ESS operation can be enhanced.

(3) The traceability management system 1 of (2) described above may have a data cooperation function with a remote monitoring system 30e that monitors a state of the ESS.

According to the above-described configuration, it is possible to sufficiently meet needs for maintenance service for performing periodic inspection, part replacement, and troubleshooting during the ESS operation period. It is possible to ensure advanced preventive maintenance, quick recovery from trouble, and operation stability at a level that cannot be implemented only by the remote monitoring system 30e.

(4) In the traceability management system 1 of (3) described above, the information processing device 20 may acquire bank identification information of each of a plurality of banks included in the ESS from the remote monitoring system 30e.

According to the above-described configuration, it is possible to improve maintenance efficiency, reduce a burden on a maintenance staff, and quickly recover from trouble at a level that cannot be implemented only by the traceability management system 1. In the ESS, the number of modules and the number of monitoring boards 44 are very large, and there is a relatively high possibility that partial replacement is required during the operation. By acquiring the bank identification information from the remote monitoring system 30e, the maintenance staff can easily specify the module, the monitoring board 44, or the energy storage module 43 that needs to be replaced.

(5) In the traceability management system 1 of (2) or (3) described above, the information processing device 20 may identifiably store traceability data of a component before replacement and traceability data of a component after replacement in the ESS.

According to the above-described configuration, it is possible to easily grasp which component in the ESS is replaced. The ESS is operated for a long period of time such as 15 or 20 years, and it is expected that a person in charge will change and a technology will change during that period. As an example in which the technology changes, even if a circuit configuration of the monitoring board 44 (CMU) is the same, a specification of an integrated circuit (IC) mounted thereon changes, a version of software executed by a microcomputer (CPU) changes and the like. According to the above-described configuration, it is possible to easily track and grasp which version of the part is used until when and which version of the part is used thereafter in a long operation period of the ESS even if a person who manages the ESS or a person who maintains the ESS changes. Therefore, it is possible to quickly investigate a cause of a trouble of the ESS operation. It is possible to provide advanced maintenance service. In cooperation with the remote monitoring system 30e, it is also possible to save a history of replacement parts, provide a report and the like as a service.

(6) In the traceability management system 1 of (2) or (3) described above, the traceability data of the components may be associated along hierarchy of the ESS including a relationship between a container 3 and a storage battery board 40.

(7) In the traceability management system 1 of (2), (3), or (6) described above, the traceability data of the components may be associated along hierarchy of the ESS including a relationship between the storage battery board 40 and the energy storage blocks 43.

According to the above-described configuration, with the same concept, the traceability management of the ESS in a plurality of different voltage bands can be performed.

(8) A traceability management method accepts traceability data of a plurality of components of an energy storage system including a plurality of housings that accommodates a plurality of energy storage blocks input from each of a plurality of inputters 30 permitted to access by a data relay device 10, acquires the traceability data from the data relay device 10, and stores in an information processing device 20 the traceability data in association with the energy storage system in such a manner that a place in the energy storage system of a component having specific traceability data can be searched for.

According to the above-described configuration, the traceability data of a plurality of components of the ESS can be accepted with high flexibility using the data relay device 10. Stable operation and preventive maintenance of the system can be performed, and reliability of ESS operation can be enhanced.

(9) In the traceability management method of (8) described above, when the energy storage blocks or components of the energy storage blocks are replaced, the traceability data of the components before replacement and the components after replacement may be read by a terminal device and transmitted to the data relay device.

According to the above-described configuration, the traceability data can be stably collected by a predetermined procedure and stored in the information processing device at the time of replacement of the energy storage blocks or the components thereof, the number of which is extremely large in the ESS, and possibility of necessary partial replacement during operation is relatively high. This enables service provision such as storage of a history of replacement parts and provision of a report.

1. A traceability management system comprising:
a data relay device that accepts traceability data of a plurality of components input from each of a plurality of inputters permitted to access; and
an information processing device that acquires the traceability data from the data relay device, and stores the traceability data in association with a local system in such a manner that a place in the local system of a component having specific traceability data can be searched for.

2. The traceability management system according to claim 1, wherein
the local system is an energy storage system including a plurality of housings that accommodates a plurality of energy storage blocks, and
the information processing device stores in a searchable manner in which place of which housing in the energy storage system the component having specific traceability data is provided.

3. The traceability management system according to claim 1, wherein
the local system is an energy storage system including a plurality of housings that accommodates a plurality of energy storage blocks,
the information processing device stores in a searchable manner in which place of which housing in the energy storage system the component having specific traceability data is provided, and
the traceability management system has a data cooperation function with a remote monitoring system that monitors a state of the energy storage system.

4. The traceability management system according to claim 1, wherein
the local system is an energy storage system including a plurality of housings that accommodates a plurality of energy storage blocks,
the information processing device stores in a searchable manner in which place of which housing in the energy storage system the component having specific traceability data is provided,
the traceability management system has a data cooperation function with a remote monitoring system that monitors a state of the energy storage system, and
the information processing device acquires bank identification information of each of a plurality of banks included in the energy storage system from the remote monitoring system.

5. The traceability management system according to claim 1, wherein
the local system is an energy storage system including a plurality of housings that accommodates a plurality of energy storage blocks
the information processing device stores in a searchable manner in which place of which housing in the energy storage system the component having specific traceability data is provided, and
the information processing device identifiably stores traceability data of a component before replacement and traceability data of a component after replacement in the energy storage system.

6. The traceability management system according to claim 1, wherein
the local system is an energy storage system including a plurality of housings that accommodates a plurality of energy storage blocks,
the information processing device stores in a searchable manner in which place of which housing in the energy storage system the component having specific traceability data is provided, and
the traceability data of the components is associated along hierarchy of the energy storage system including a relationship between a container and a storage battery board.

7. The traceability management system according to claim 1, wherein
the local system is an energy storage system including a plurality of housings that accommodates a plurality of energy storage blocks,
the information processing device stores in a searchable manner in which place of which housing in the energy storage system the component having specific traceability data is provided, and
the traceability data of the components is associated along hierarchy of the energy storage system including a relationship between the storage battery board and the energy storage blocks.

8. A traceability management method comprising:
accepting traceability data of a plurality of components of an energy storage system including a plurality of housings that accommodates a plurality of energy storage blocks input from each of a plurality of inputters permitted to access by a data relay device;
acquiring the traceability data from the data relay device as an event or in response to a request, and storing in an information processing device the traceability data in association with the energy storage system in such a manner that a place in the energy storage system of a component having specific traceability data can be searched for.

9. The traceability management method according to claim 8, further comprising
reading, when the energy storage blocks or components of the energy storage blocks are replaced, the traceability data of the components before replacement and the components after replacement by a terminal device and transmitting to the data relay device.
